(19) United States
(12) Patent Application Publication
(10) Pub. No.: US 2026/0134720 A1
(43) Pub. Date: May 14, 2026

(54) API CONTROL DEVICE, STORAGE MEDIUM, AND CONTROL METHOD

(71) Applicant: DENSO CORPORATION, Kariya-city (JP)

(72) Inventors: Hiroki KITO, Kariya-city (JP); Hideyuki HONYA, Kariya-city (JP); Hideyuki YAMAGUCHI, Kariya-city (JP)

(21) Appl. No.: 19/429,843

(22) Filed: Dec. 22, 2025

Related U.S. Application Data
(63) Continuation of application No. PCT/JP2024/023016, filed on Jun. 25, 2024.

(30) Foreign Application Priority Data
Jun. 28, 2023 (JP) 2023-105970

(51) Int. Cl. G07C 5/00; G06F 9/54; G06F 21/44

(52) U.S. Cl. CPC G07C 5/004; G06F 9/541; G06F 21/44

(57) ABSTRACT

A power consumption consumed by using API is acquired when an application program on a vehicle accesses the API. A travelable amount indicating how far the vehicle can travel is acquired. A reduction amount of the travelable amount that is reduced due to the power consumption is acquired. It is determined whether to permit access to the API by the application program based on the travelable amount and the reduction amount.

### CROSS REFERENCE TO RELATED APPLICATION

The present application is a continuation application of International Patent Application No. PCT/JP 2024/023016 filed on Jun. 25, 2024, which designated the U.S. and claims the benefit of priority from Japanese Patent Application No. 2023-105970 filed on Jun. 28, 2023. The entire disclosures of all of the above applications are incorporated herein by reference.

### TECHNICAL FIELD

The present disclosure relates to a technique in which an in-vehicle application program accesses an application programming interface (API) to execute processing.

### BACKGROUND

There is a technique for analyzing the power consumption of an application program by acquiring the power consumption of modules, which are program components used by the application program installed in a wireless communication device.

### SUMMARY

According to one aspect of the present disclosure, an API control device includes: at least one of (i) a circuit and (ii) a processor with a memory storing computer program code executable by the processor, the at least one of the circuit and the processor configured to cause the API control device to:
acquire power consumption consumed by using an application programming interface when an application program on a vehicle accesses the application programming interface;
acquire a travelable amount indicating how far the vehicle is able to travel;
acquire a reduction amount of the travelable amount that is reduced due to the power consumption; and
determine whether to permit access to the application programming interface by the application program based on the travelable amount and the reduction amount.

### BRIEF DESCRIPTION OF DRAWINGS

FIG. 1 is a block diagram showing a configuration of an API control device according to a first embodiment.

FIG. 2 is an explanatory diagram showing access to an API by an application program.

FIG. 3 is an explanatory diagram showing a relationship between power consumption and operation mode for each API.

FIG. 4 is an explanatory diagram showing a setting of an operation mode of an application program.

FIG. 5 is a sequence diagram showing API control processing by the API control device.

FIG. 6 is another sequence diagram showing API control processing by the API control device.

FIG. 7 is an explanatory diagram showing a relationship between power consumption and operation mode for each API according to a second embodiment.

FIG. 8 is a block diagram showing a configuration of an API control device according to a third embodiment.

### DETAILED DESCRIPTION

There is a technique for analyzing the power consumption of an application program by acquiring the power consumption of modules, which are program components used by the application program installed in a wireless communication device. In the technology, a method is used to name a module.

In the case of in-vehicle application programs, it is desirable that the created application programs execute processes using appropriate methods regardless of differences in the vehicle manufacturer, model, etc. Therefore, it is conceivable that an application program accesses an API, and an appropriate method is selected regardless of differences in the vehicle manufacturer, model, etc.

However, as a result of detailed investigation by the inventors, it may not take into consideration the power consumption caused by an application program accessing an API in the technology.

In the case of an in-vehicle application program, the power consumed by accessing the API is a factor that reduces the travelable amount, which indicates how far the vehicle can travel. Therefore, it is desirable to take into consideration the power consumption consumed by an in-vehicle application program accessing an API.

One aspect of the present disclosure is to provide a technique that takes into account power consumption consumed by an in-vehicle application program accessing an API.

An API control device according to one aspect of the present disclosure includes a power consumption acquisition unit, a travelable distance acquisition unit, a reduction acquisition unit, and an access determination unit.

The power consumption acquisition unit acquires the power consumption consumed by using the API when an in-vehicle application program accesses the API. The travel amount acquisition unit acquires a travelable amount indicating how far the vehicle can travel.

The reduction acquisition unit acquires a reduction amount, which is a reduction in the travelable amount due to the power consumption acquired by the power consumption acquisition unit.

The access determination unit determines whether to permit access to the API by the application program based on the travelable amount acquired by the travel amount acquisition unit and the reduction amount acquired by the reduction acquisition unit.

An API control program according to another aspect of the present disclosure causes a computer to function as a power consumption acquisition unit, a travel amount acquisition unit, a reduction acquisition unit, and an access determination unit of the API control device.

According to this configuration, by taking into consideration the power consumption when the in-vehicle application program accesses the API, it is possible to appropriately determine whether or not the application program is allowed to access the API.

Hereinbelow, embodiments of the present disclosure will be described with reference to the drawings.

### First Embodiment

### 1-1. Configuration

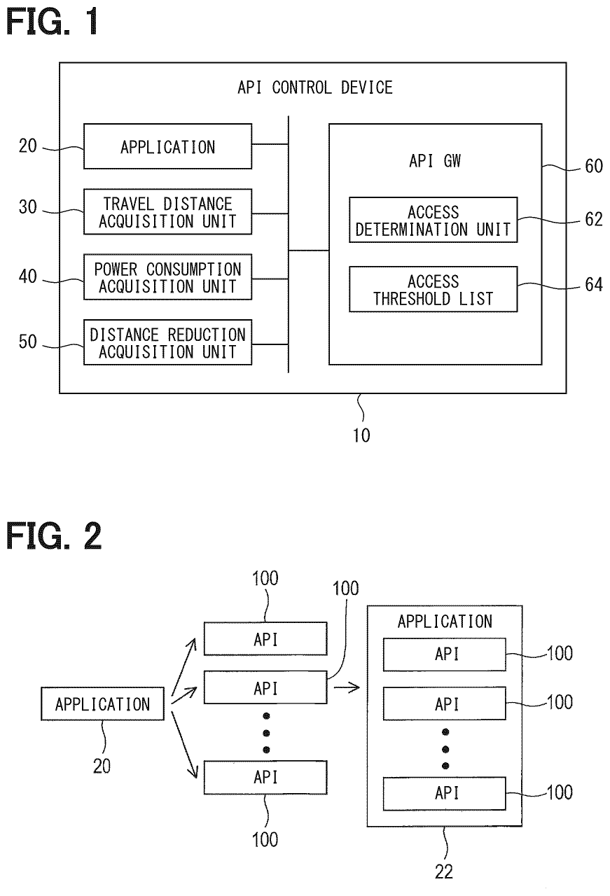

The API control device 10 shown in FIG. 1 is mounted on a vehicle. The vehicle of the first embodiment travels by driving an electric motor with electric power charged in a battery.

The API control device 10 includes an application program 20, a travel distance acquisition unit 30, a power consumption acquisition unit 40, a distance reduction acquisition unit 50, and an API GW 60. GW stands for Gateway. Hereinafter, the application program may be referred to as application.

A method for executing a vehicle control process or the like is called when the application 20 accesses the API via the API GW 60.

For example, the API may be an API for reading the vehicle speed, an API for opening the vehicle windows, an API for turning on the vehicle lights, an API for turning on the autonomous driving, an API for setting the air conditioning temperature, and the like.

The travel distance acquisition unit 30 calculates and acquires the travelable distance that the vehicle can travel based on the current remaining battery charge of the vehicle, using the following Formula (1). The travelable distance is a distance that indicates how far the vehicle can travel.

travelable distance [km]=remaining battery power [kWh]×electric efficiency [km/kWh] Formula (1)

The electric efficiency [km/kWh] in Formula (1) represents a distance that the vehicle can travel per unit of electricity, and the value is set for each vehicle by measurement or the like. The electric efficiency [km/kWh] may be a fixed value measured in advance, or may be measured and updated periodically while the vehicle is traveling.

The power consumption acquisition unit 40 acquires the power consumption consumed by the API when the API calls a method every time the application 20 accesses the API. The power consumption represents a reduction in the travelable amount due to the power consumption. The power consumption of the API may be a fixed value measured in advance, or may be measured and updated periodically while the vehicle is traveling.

The power consumption of the API is the sum of the power consumption of the methods that the API calls. The power consumption of each method is the total power consumed by the hardware used by the method, such as the CPU, ROM, RAM, various actuators, lights, and the like.

As shown in FIG. 2, the API 100 accessed by the application 20 may include an API 100 that calls the application 22 accessing plural APIs 100. In this case, the power consumption acquisition unit 40 obtains the total power consumption of the plural APIs 100 accessed by the application 22 as the power consumption consumed by the application 20 accessing the API 100 that calls the application 22.

An example of the application 22 that accesses the plural APIs 100 is an application for comfortable driving. The application for comfortable driving determines the passenger's physical condition from the facial expressions while the vehicle is driving autonomously, and adjusts the vehicle speed and seat position, opens and closes the power windows, etc.

The distance reduction acquisition unit 50 acquires the distance that the vehicle can travel with the power consumed by the application 20 accessing the API 100, that is, the distance reduction of the vehicle that is reduced by the power consumed by the API. The distance reduction acquisition unit 50 calculates and acquires the distance reduction based on the following Formula (2).

distance reduction [km]=power consumption [kWh]×electric efficiency [km/kWh] Formula (2)

The API GW 60 includes an access determination unit 62 and an access threshold list 64.

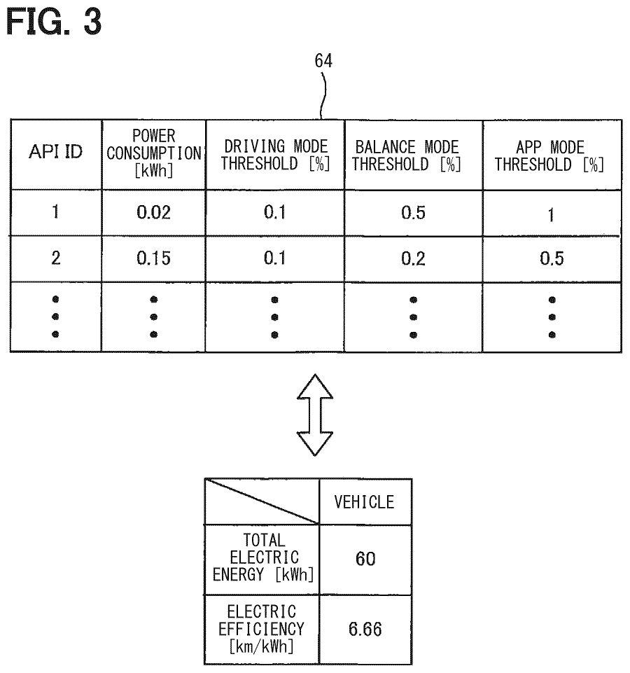

The access determination unit 62 determines whether or not to permit the application 20 to access the API 100. Specifically, the access determination unit 62 determines whether or not to permit the application 20 to access the API 100 based on the access threshold list 64 shown in FIG. 3, Formula (1) and Formula (2).

Each column of the access threshold list 64 is set for each API ID assigned to each API 100. In addition to the API ID, each field contains the power consumption, the driving mode threshold, the balance mode threshold, and the application mode threshold.

As described above, the power consumption is power consumed when the application 20 accesses the API 100. In the case of the API 100 that calls the application 22 that accesses multiple APIs 100, the total power consumption of the multiple APIs 100 is set in the access threshold list 64 as the power consumption.

The driving mode threshold, the balance mode threshold, and the application mode threshold are different values set corresponding to the driving mode, the balance mode, and the application mode, respectively, which are the operation modes of the application 20. The operation modes each represent a different allowable level when the access determination unit 62 determines whether or not to permit access to the API 100, and are set corresponding to the application 20.

The driving mode threshold, the balance mode threshold, and the application mode threshold are each a threshold for a ratio of the distance reduction calculated from Formula (2) to the travelable distance of the vehicle. The ratio of the distance reduction to the travelable distance of the vehicle is calculated using the following Formula (3).

ratio [%]=(distance reduction/travelable distance)×100 Formula (3)

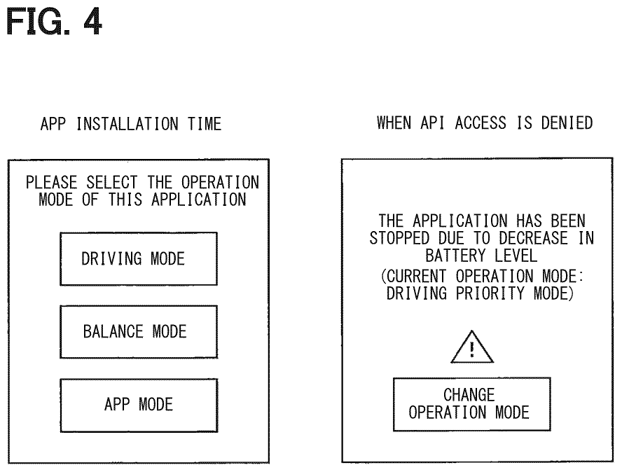

As shown on the left side of FIG. 4, the operation mode of the application 20 is selected by the user or the like when the application 20 is installed, from the driving mode, the balance mode, and the application mode.

Furthermore, the operation mode of the application 20 may be changed as needed while the vehicle is traveling. For example, as shown on the right side of FIG. 4, the operating mode of the application 20 may be changed while the vehicle is traveling in order to execute the application 20, if access to the API 100 by the application 20 is prohibited and execution of the application 20 is stopped due to a decrease in battery power.

The driving mode prioritizes the vehicle traveling over the execution of the application 20, and the application mode prioritizes execution of the application 20 over the vehicle traveling. The balance mode does not prioritize either the vehicle traveling or execution of the application 20, but considers the balance.

Next, the access determination process executed by the access determination unit 62 will be described.

For example, when the application 20 accesses API_ID=1 in FIG. 3, the electric efficiency is 6.66 [km/kWh] and the power consumption is 0.02 [kWh], so the distance reduction [km] is calculated as 0.02×6.66=0.1332 [km] using Formula (2).

As shown in FIG. 3, in the case of a battery with a total electric energy of 60 [kWh], if the charge level is 25%, the remaining power of the battery is 60×0.25=15 [kWh], and therefore the travelable distance of the vehicle can be calculated from Formula (1) as 15×6.66=99.9 [km].

The ratio of the distance reduction to the travelable distance is (0.1332/99.9)×100, which is approximately 0.133 [%].

If the ratio of the distance reduction to the travelable distance, 0.133 [%], exceeds the threshold value of each operating mode shown in FIG. 3, the access determination unit 62 determines that access to the API 100 by the application 20 cannot be permitted in the corresponding operating mode and therefore should be prohibited.

If the ratio of the distance reduction to the travelable distance, 0.133 [%], is equal to or less than the threshold value of each operation mode shown in FIG. 3, the access determination unit 62 determines that access to the API 100 by the application 20 in the corresponding operation mode is permitted.

In the case of the application 20 that accesses API_ID=1, from FIG. 3, the driving mode threshold=0.1<0.133<balance mode threshold=0.5. Therefore, if the operation mode is the driving mode, the access to API_ID=1 is prohibited, and if the operation mode is the balance mode or the application mode, the access to API_ID=1 is permitted.

Furthermore, when the application 20 accesses API_ID=2 in FIG. 3, the electric efficiency is 6.66 [km/kWh] and the power consumption is 0.15 [kWh], so the distance reduction [km] is calculated as 0.15×6.66=0.999 [km], using Formula (2).

As shown in FIG. 3, in the case of a battery with a total electric energy of 60 [kWh], when the charge level is 25%, the remaining power of the battery is 60×0.25=15 [kWh], so the travelable distance of the vehicle is 15×6.66=99.9 [km].

The ratio of the distance reduction to the travelable distance is (distance reduction/travelable distance)×100=(0.999/99.9)×100=1 [%].

In the case of the application 20 accessing API_ID=2, the application mode threshold=0.5<1, as shown in FIG. 3. Therefore, the access to API_ ID=2 is prohibited in any operation mode.

### 1-2. Process

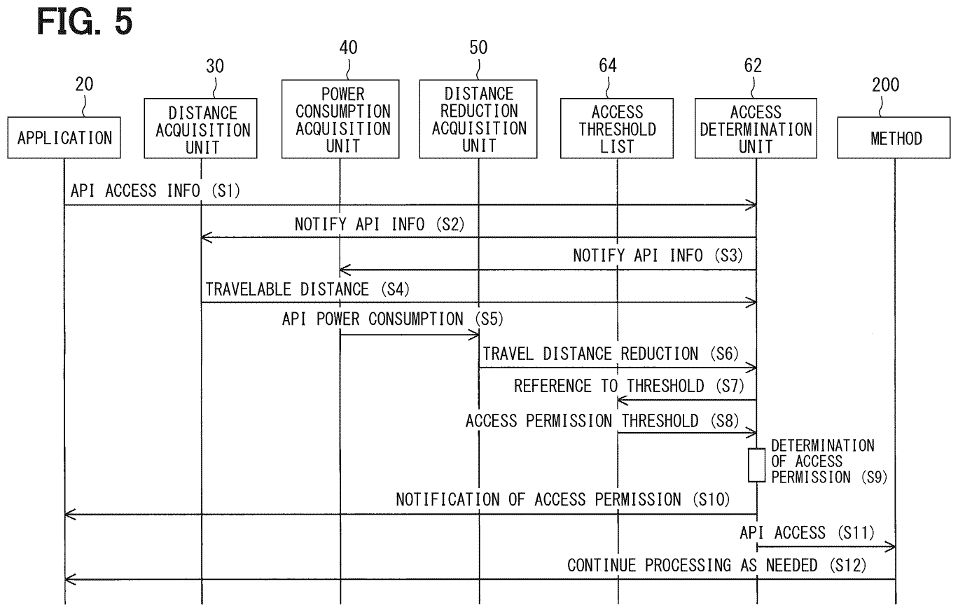

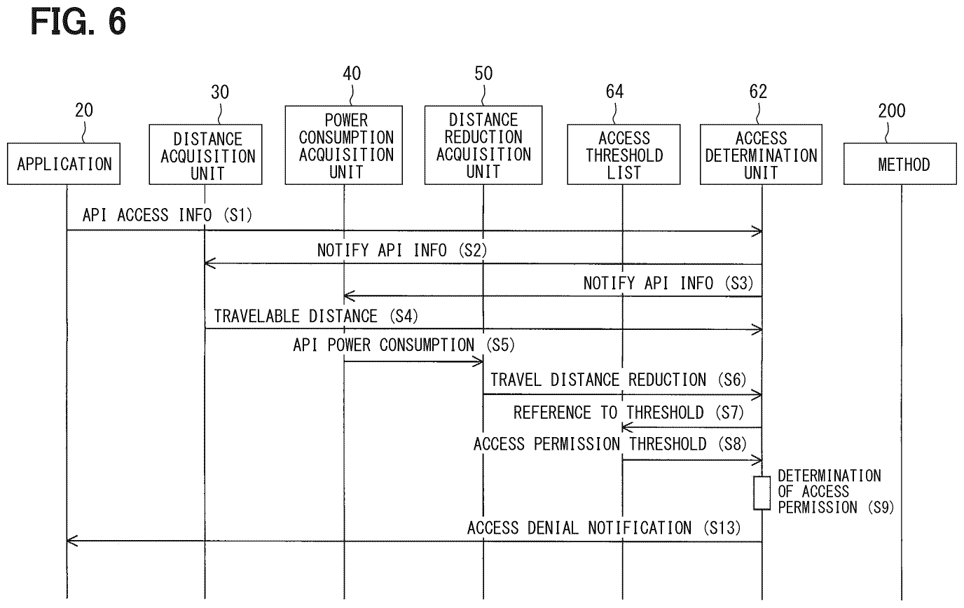

The API control process executed by the API control device 10 will be described with reference to FIGS. 5 and 6.

In S1 of FIG. 5, the application 20 notifies the access determination unit 62 of, for example, an API_ID as information about the API 100 to be accessed.

In S2 and S3, the access determination unit 62 notifies the travel distance acquisition unit 30 and the power consumption acquisition unit 40 of the API_ID as information on the API 100 accessed by the application 20.

In S4, the travel distance acquisition unit 30 calculates and acquires the travelable distance of the vehicle based on Formula (1) and notifies the access determination unit 62 of the result.

In S5, the power consumption acquisition unit 40 refers to the access threshold list 64 based on the API_ID of the API 100 being accessed, obtains the power consumption of the API 100 being accessed, and notifies the distance reduction acquisition unit 50 of the power consumption.

In S6, the distance reduction acquisition unit 50 calculates and acquires the distance reduction using Formula (2) based on the power consumption notified by the power consumption acquisition unit 40 and notifies the access determination unit 62 of the calculated distance reduction.

In S7 and S8, the access determination unit 62 refers to the access threshold list 64 based on the API_ID of the API 100 accessed by the application 20 and obtains the threshold of the API 100 to be accessed.

In S9, the access determination unit 62 determines whether or not to permit the application 20 to access the API 100 based on the above-described access determination process.

If access to the API 100 is permitted, the access determination unit 62 notifies the application 20 that access to the API 100 is permitted, in S10.

In S11, the access determination unit 62 accesses the API 100 of the API_ID notified by the application 20 and calls the method 200. In S12, the called method 200 notifies the application 20 of the processing result of the method 200 as necessary.

If the access determination unit 62 determines in S9 that access to the API 100 cannot be permitted, the access determination unit 62 notifies the application 20, in S13 of FIG. 6, that access to the API 100 is prohibited.

As shown on the right side of FIG. 4, since the access determination unit 62 cannot access the API 100 in the current operation mode, it is inquired to the vehicle occupant on a display or the like whether or not to change the operation mode. When the operation mode is changed by the occupant, the access determination unit 62 executes the access permission/denial determination in S9 again.

In the first embodiment, the travelable distance corresponds to a travelable amount, and the distance reduction corresponds to a reduction amount of the travelable amount. Further, the travel distance acquisition unit 30 corresponds to a travelable amount acquisition unit, and the distance reduction acquisition unit 50 corresponds to a reduction acquisition unit.

Furthermore, S4 corresponds to a processing of the travel distance acquisition unit 30, S5 corresponds to a processing of the power consumption acquisition unit 40, S6 corresponds to a processing of the distance reduction acquisition unit 50, and S7 to S9 correspond to a processing of the access determination unit 62.

### 1-3. Effects

The first embodiment can provide the following effects.

(1a) The API control device 10 determines whether or not to allow access to the API 100 based on the travelable distance that the vehicle can travel when the in-vehicle application 20 accesses the API 100 and the reduction amount calculated from the power consumption consumed when the API 100 is accessed.

Therefore, according to the API control device 10, the power consumption consumed by the application 20 accessing the API 100 is taken into consideration, and therefore it is possible to appropriately determine whether or not the API 100 can be accessed.

(1b) According to the API control device 10, different thresholds are set depending on the operation mode of the API 100, so that whether or not to allow access to the API 100 can be appropriately determined depending on the operation mode.

(1c) According to the API control device 10, the operation mode of the API 100 can be changed while the vehicle is traveling, so that the operation mode of the API 100 can be appropriately set according to the remaining power level of the battery.

### Second Embodiment

### 2-1. Difference from First Embodiment

Since the basic configuration of a second embodiment is similar to the first embodiment, the difference will be described below. The same reference numerals as in the first embodiment denote the same elements, and reference is made to the preceding description.

In the first embodiment, the vehicle travels by driving the electric motor with the electric power charged in the battery. In the second embodiment, the vehicle runs using the driving force of an internal combustion engine.

Next, the access determination process executed by the access determination unit 62 in the second embodiment will be described.

The current travelable distance of the vehicle is calculated using the following Formula (4).

travelable distance [km]=fuel efficiency [km/L]×remaining fuel amount [L] Formula (4)

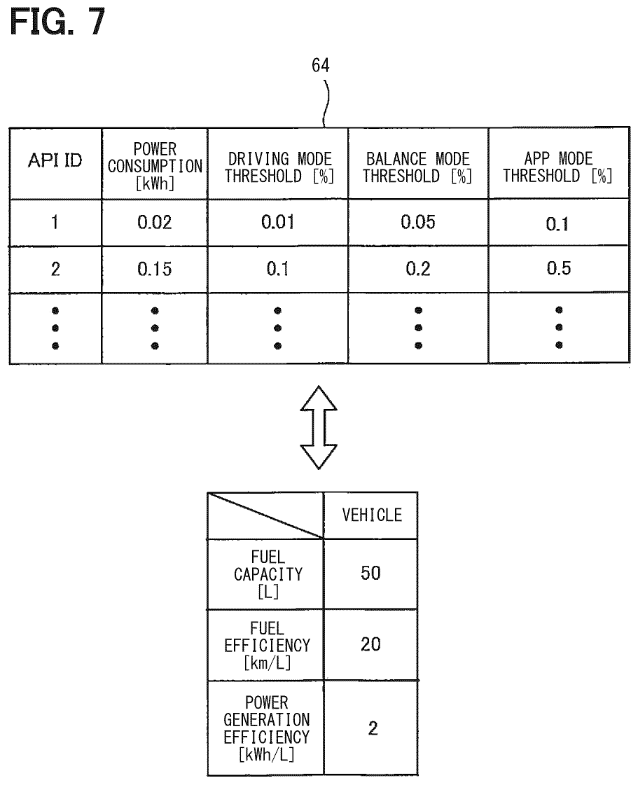

For example, as shown in FIG. 7, in a vehicle with a fuel capacity of 50 [L] and a fuel efficiency of 20 [km/L], if the remaining fuel amount is 50 [%], the travelable distance [km] is calculated from Formula (4) as follows: travelable distance=20 [km/L]×25 [L]=500 [km].

The distance reduction is calculated using the following Formula (5). In Formula (5), (power consumption [kWh]/power generation efficiency [kWh/L]) represents the amount of fuel consumed for the power consumption.

distance reduction [km]=fuel efficiency [km/L]×(power consumption [kWh]/power generation efficiency [kWh/L]) Formula (5)

For example, when the application 20 accesses API_ID=1 in FIG. 7, the power consumption is 0.02 [kWh], the fuel efficiency is 20 [km/L], and the power generation efficiency is 2 [kWh/L], so the distance reduction [km] is calculated from Formula (5) as follows: distance reduction [km]=20 [km/L]×(0.02[kWh]/2 [kWh/L])=0.2 [km].

The ratio of the distance reduction to the travelable distance is (0.2/500)×100=0.04[%].

In the case of the application 20 that accesses API_ID=1, from FIG. 7, the driving mode threshold=0.01<0.04<balance mode threshold=0.05. Therefore, if the operation mode is the driving mode, access to API_ID=1 is prohibited, and if the operation mode is the balance mode or the application mode, access to API_ID=1 is permitted.

Furthermore, when the application 20 accesses API_ID=2 in FIG. 7, the power consumption is 0.15 [kWh], and therefore the distance reduction [km] is calculated from Formula (5) as 20 [km/L]×(0.15 [kWh]/2 [kWh/L])=1.5 [km].

When the remaining fuel amount is 20%, the travelable distance of the vehicle is 50 [L]×0.2×20 [km/L]=200 [km].

The ratio of the distance reduction to the travelable distance is (1.5 [km]/200 [km])×100=0.75 [%].

In the case of the application 20 accessing API_ID=2, as shown in FIG. 7, the application mode threshold=0.5<0.75. Therefore, access to API_ID=2 is prohibited in any operation mode.

### 2-2. Effects

In the second embodiment, in addition to the effects (1a) and (1b) of the first embodiment, the following effects can be obtained.

(2a) The API control device 10 calculates the travelable distance and the distance reduction used to determine whether or not the API 100 can be accessed, taking into account the remaining fuel amount and the power generation efficiency. Therefore, the API control device 10 can appropriately determine whether or not access to the API 100 is possible depending on the amount of power that can be generated using the remaining amount of fuel, and can also appropriately set the operating mode of the API 100 depending on the amount of power that can be generated using the remaining amount of fuel.

### Third Embodiment

### 3-1. Difference from First Embodiment

A vehicle of the third embodiment, like the vehicle of the first embodiment, travels by driving an electric motor with electric power charged in a battery. The basic configuration of the third embodiment is similar to that of the first embodiment, and differences will be described below. The same reference numerals as those in the first embodiment indicate the same configurations, and refer to the preceding descriptions.

In the first embodiment, whether or not to permit the application 20 to access the API 100 is determined based on whether or not the ratio of the distance reduction to the travelable distance of the vehicle exceeds a threshold value.

In the third embodiment, whether to allow the application 20 to access the API 100 is determined based on whether the ratio of power consumption consumed by accessing the API 100 to the usable power of the vehicle exceeds a threshold value. In this respect, the third embodiment differs from the first embodiment.

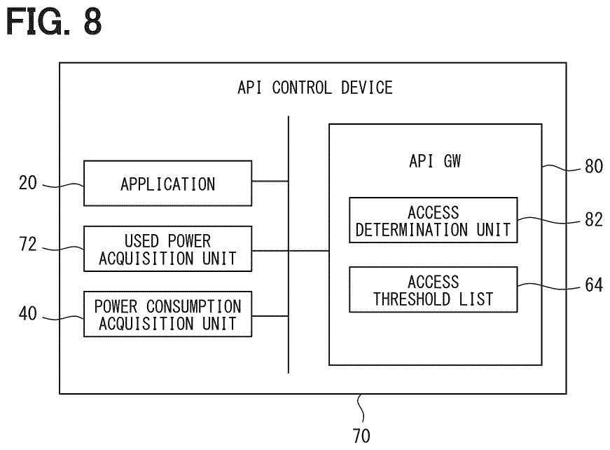

As shown in FIG. 8, the API control device 70 of the third embodiment includes an application 20, a power consumption acquisition unit 40, a used power acquisition unit 72, and an API GW 80.

The API GW 80 includes an access threshold list 64 and an access determination unit 82.

The used power acquisition unit 72 calculates and acquires the usable power [kWh] of the vehicle, using the following Formula (6), from the total power [kWh] of the battery and the charge amount [%] of the battery. The usable power is a travelable amount that indicates how far the vehicle can travel.

usable power [kWh]=total power [kWh]×battery charge [%] Formula (6)

As in the first embodiment, the power consumption acquisition unit 40 refers to the access threshold list 64 based on the API_ID of the API 100 accessed by the application 20, and obtains the power consumption consumed when the API 100 is accessed.

The access determination unit 82 refers to the access threshold list 64 based on the API_ID of the API 100 to be accessed, and obtains a threshold corresponding to the operation mode of the application 100 for the API 100 to be accessed.

As shown in FIG. 3 of the first embodiment, in the case of a battery with a total electric energy of 60 [kWh], if the charge level is 25%, the remaining power of the battery, which is usable power, is 60×0.25=15 [kWh]. When the application 20 accesses API_ID=1 shown in FIG. 3 of the first embodiment, the power consumption is 0.02 [kWh].

Therefore, when the charge level of battery with a total electric energy of 60 [kWh] is 25% and the application 20 accesses API_ID=1 shown in FIG. 3 of the first embodiment, the ratio [%] is calculated as (0.02/15)×100, which is approximately 0.133 [%].

The access determination unit 82 determines whether or not to permit the application 20 to access the API 100 based on this ratio and the threshold value of the operation mode set for the application 20.

In the third embodiment, the usable power corresponds to a travelable amount, and the power consumption corresponds to a reduction amount. Furthermore, the used power acquisition unit 72 corresponds to a travelable amount acquisition unit, and the power consumption acquisition unit 40 corresponds to a power consumption acquisition unit and a reduction acquisition unit.

### 3-2. Effect

In the third embodiment, in addition to the effects (1b) and (1c) of the first embodiment, the following effects can be obtained.

(3a) When the in-vehicle application 20 accesses the API 100, the API control device 70 determines whether or not to allow access to the API 100 based on the usable power available to the vehicle and the power consumption consumed by accessing the API 100.

Therefore, according to the API control device 70, the power consumption consumed by the application 20 accessing the API 100 is taken into consideration, and therefore it is possible to appropriately determine whether or not the API 100 can be accessed.

### Other Embodiments

Although the embodiments of the present disclosure have been described above, the present disclosure is not limited to the embodiments described above, and various modifications can be made to implement the present disclosure.

(4a) In the embodiments, the vehicle uses only an electric motor or only an internal combustion engine as a drive source. In other embodiments, like a hybrid vehicle, either an electric motor or an internal combustion engine may be selected and used as the drive source depending on the running state of the vehicle. Alternatively, an electric motor may be used as the driving source, and the internal combustion engine may be used to charge the battery.

In this case, whether or not access to the API 100 is permitted may be determined based on the travelable distance obtained based on the remaining battery charge and the remaining fuel amount, and the distance reduction obtained from the power consumption consumed by the application 20 accessing the API 100.

(4b) In the embodiments, an operation mode is selected from plural operation modes according to the API 100 and set, and the operation mode can be changed while the vehicle is running. In other embodiments, each API 100 may have one fixed mode of operation.

(4c) The API control device 10, 70 and the techniques described herein may be implemented by a special purpose computer provided by configuring a processor and memory programmed to perform one or more functions embodied in a computer program.

Alternatively, the API control device 10, 70 and the techniques described in this disclosure may be implemented by a special purpose computer provided by configuring a processor with one or more dedicated hardware logic circuits.

Alternatively, the API control device 10, 70 and techniques described in this disclosure may be implemented by one or more special-purpose computers configured by a combination of a processor and memory programmed to perform one or more functions and a processor configured with one or more hardware logic circuits.

Furthermore, the computer program may be stored in a computer-readable non-transitory tangible storage medium as instructions executed by the computer. The method for realizing the functions of each unit included in the API control device 10, 70 does not necessarily need to include software, and all of the functions may be realized using one or more pieces of hardware.

(4d) The multiple functions of one component in the embodiments may be implemented by multiple components, or a function of one component may be implemented by multiple components. Further, multiple functions of multiple elements may be implemented by one element, or one function implemented by multiple elements may be implemented by one element. A part of the configuration of the embodiment may be omitted as appropriate. At least a part of the configuration of the embodiment may be added to or replaced with the configuration of another embodiment.

(4e) In addition to the API control device 10, the present disclosure can also be realized in various forms, such as an API system having the API control device 10 as a component, an API control program for causing a computer to function as the API control device 10, a non-transitory tangible storage medium such as a semiconductor memory on which this API control program is recorded, or an API control method.

What is claimed is:

1. An API control device comprising: at least one of (i) a circuit and (ii) a processor with a memory storing computer program code executable by the processor, the at least one of the circuit and the processor configured to cause the API control device to:
acquire power consumption consumed by using an application programming interface when an application program on a vehicle accesses the application programming interface;
acquire a travelable amount indicating how far the vehicle is able to travel;
acquire a reduction amount of the travelable amount that is reduced due to the power consumption; and
determine whether to permit access to the application programming interface by the application program based on the travelable amount and the reduction amount.

2. The API control device according to claim 1, wherein the at least one of the circuit and the processor is configured to cause the API control device to:
acquire, as the travelable amount, a travelable distance that the vehicle is able to travel,
acquire, as the reduction amount, a distance reduction amount of the travelable distance that is reduced due to the power consumption, and
determine whether to permit access to the application programming interface by the application program based on the travelable distance and the distance reduction amount.

3. The API control device according to claim 1, wherein the at least one of the circuit and the processor is configured to cause the API control device to:
acquire, as the travelable amount, a usable power by the vehicle,
acquire, as the reduction amount, the power consumption, and
determine whether to permit access to the application programming interface by the application program based on the usable power and the power consumption.

4. The API control device according to claim 1, wherein
the application program is set with one of a plurality of operation modes that represent different allowable levels when it is determined whether to permit access to the application programming interface, and
the at least one of the circuit and the processor is configured to determine whether to permit the application program to access the application programming interface based on the operation mode set for the application program.

5. The API control device according to claim 4, wherein
a different threshold value is set for the reduction amount with respect to the travelable amount, in response to the operation mode, for each of the plurality of operation modes, and
the at least one of the circuit and the processor is configured to determine whether to permit the application program to access the application programming interface based on the threshold value set according to the operation mode.

6. The API control device according to claim 5, wherein the at least one of the circuit and the processor is configured to cause the API control device to:
prohibit access to the application programming interface by the application program when a ratio of the reduction amount to the travelable amount exceeds the threshold value.

7. The API control device according to claim 1, wherein the at least one of the circuit and the processor is configured to cause the API control device to:
acquire, when the application programming interface calls the application program that accesses a plurality of application programming interfaces, a total of the power consumption consumed by using the plurality of application programming interfaces.

8. A non-transitory computer readable storage medium storing a computer program comprising instructions configured to, when executed by a computer, cause the computer to
acquire power consumption consumed by using an application programming interface when an application program on a vehicle accesses the application programming interface;
acquire a travelable amount indicating how far the vehicle is able to travel;
acquire a reduction amount of the travelable amount that is reduced due to the power consumption; and
determine whether to permit access to the application programming interface of the application program based on the travelable amount and the reduction amount.

9. A control method comprising:
acquiring a power consumption consumed by using an application programming interface when an application program on a vehicle accesses the application programming interface;
acquiring a travelable amount indicating how far the vehicle is able to travel;
acquiring a reduction amount of the travelable amount that is reduced due to the power consumption; and
determining whether to permit the application program to access the application programming interface based on the travelable amount and the reduction amount.
